(19) United States
(12) Patent Application Publication
(10) Pub. No.: US 2003/0078765 A1
(43) Pub. Date: Apr. 24, 2003

(54) Method and apparatus for simulating a multi-industry economy

(76) Inventor: Kurt Hoffmaster, Horsham, PA (US)

Correspondence Address: Thomas J. McWilliams, REED SMITH LLP, 2500 One Liberty Place, 1650 Market Street, Philadelphia, PA, 19103-7301, US

(21) Appl. No.: 10/035,913

(22) Filed: Oct. 24, 2001

(51) Int. Cl. G06F 9/45

(52) U.S. Cl. 703/22

(57) ABSTRACT

A method and system allowing participation in a multiple-industry, self-perpetuating virtual economy using a communicative connection and an independent third party, is disclosed. The simulated economy allows multiple participants, each operating interdependent organizations which produce or utilize products entered into the commerce. The independent and non-interested third party whose operates key functions within the economy for which there is no individual participant, and records activity within the economy.

### BACKGROUND OF THE INVENTION

1. Field of the Invention

The present invention is directed generally to a method and apparatus for conducting an economic simulation and, more particularly, to an apparatus and method for simulating a multiple industry economy between interactive participants.

2. Description of the Background

Numerous educational tools exist for learning the skills necessary to perform in the business world, although such tools may not specifically address the business of producing a specific product. Additionally, obtaining even a brief experience within a specific industry is often impeded by daunting entry criteria. For example, if one desired to operate a paper products manufacturing business that made cups, napkins, paper plates, copying paper, and poster board one might need either a technical degree, a business degree, or both, one might need to gain admittance into the industry, and to spend years therein before the critical decision-making skills could be learned, utilized, and tested in the real-world economy in that specific industry.

Additionally, it might be desirable to gain multiple industry experience to broaden one's business skills. For example, a paper products manufacturing businessperson might gain experience in a related field, such as a paper products customer or as a paper mill operator, in order to understand the economic interactions surrounding the core business. A business student, desiring to get experience in one or more specialized industries to improve personal knowledge and marketability, might wish to be exposed to multiple divergent industries and the respective operation of those industries.

The need therefore exists for a tool that permits the interactive simulation, with other human participants, of an economy wherein specific industry skills may be developed and tested for performance. The simulated economy may allow business decision and acumen to control the success of the enterprise.

### BRIEF SUMMARY OF THE INVENTION

The present invention is directed to a system for providing a channel between at least two organizations, wherein the organizations are linearly communicatively connected. The system may include an account for each of the at least two organizations, a set of defined attributes for each of the at least two organizations, wherein each of the at least two sets is correspondent to one of the accounts, wherein the set defines at least one input to the organization correspondent to the one of the accounts and at least one output of the organization correspondent to the one of the accounts, a communicative connection that provides for at least one of the organizations to control the account of that at least one organization, and that provides for a linear interacting of the at least one of the organizations with other of the at least two organizations, wherein the linear interacting comprises trading of the set correspondent to the at least one of said organizations within the system by the at least one of the organizations with other of the at least two organizations, and a disinterested third-party connection that provides for the creation of each of the accounts, that records activities occurring over the communicative connection, and that serves as a temporary organization if the system is without at least one of the at least two organizations necessary for at least one of the linear communications. Each of the accounts may be created by the independent third party in accordance with a pay-in by each of the organizations. The pay-ins may placed in an investment account, wherein the investment account is invested by the independent third party, and wherein proceeds of the investment account may be distributed to each of the organizations, or wherein proceeds of said investment account may be retained by the independent third party.

The present invention is additionally directed to a method of providing a linear channel of communication between at least two organizations. The method includes creating an account for each of at least two organizations, identifying and assigning a set of defined attributes for each of the at least two organizations, establishing a communicative connection allowing at least one of said organizations to manage and control the account of that at least one organization, and to linearly interact with other of said at least two organizations, serving as a temporary organization in an absence of at least one of said at least two organizations necessary for a trading, recording the trading of the sets of defined attributes over the communicative connection, and allowing for the trading of the sets of defined attributes between the organizations.

Thus, the present invention provides a tool that permits the interactive simulation, with other human participants, of an economy wherein specific industry skills may be developed and tested for performance, wherein the simulated economy may allow business decision and acumen to control the success of the enterprise. Those and other advantages and benefits of the present invention will become apparent from the detailed description of the invention hereinbelow.

### BRIEF DESCRIPTION OF THE SEVERAL VIEWS OF THE DRAWING

For the present invention to be clearly understood and readily practiced, the present invention will be described in conjunction with the following figures, wherein:

FIG. 1 is a block diagram illustrating an economic interrelation in the present invention;

FIG. 2 is a schematic diagram illustrating a hardware and software embodiment of the simulation of the present invention; and

FIG. 3 is a block diagram illustrating a specific economic interaction in the present invention.

### DETAILED DESCRIPTION OF THE INVENTION

It is to be understood that the figures and descriptions of the present invention have been simplified to illustrate elements that are relevant for a clear understanding of the present invention, while eliminating, for purposes of clarity, many other elements found in a typical simulation system. Those of ordinary skill in the art will recognize that other elements are desirable and/or required in order to implement the present invention. However, because such elements are well known in the art, and because they do not facilitate a better understanding of the present invention, a discussion of such elements is not provided herein.

The present invention provides a method and apparatus that allows individuals to participate in a viable, self-perpetuating simulated economy, via a client server system accessible over a network, such as an Intranet or the Internet. The simulated economy may be, for example, an interactive learning environment wherein the participants retain the potential to make a profit by acting as agents within the simulated economy. The structure and forum for the economy is preferably provided by an independent third party of non-interest. The independent third party remains independent of the economy's affairs, except for regulation and governing duties over those affairs, as discussed further hereinbelow. The independent third party may create the structure for the simulated economy, wherein the structure encompasses each virtual industry and each virtual organization therein, by programming the client system with each individual working aspect of each virtual organization within that industry, as well as each characteristic of each virtual product that is manufactured, bought or sold by each virtual organization.

The simulated economy provides a forum wherein an individual may organize and manage a virtual company having a working Enterprise Resource System, which Enterprise Resource System (“ERS”) is a computer system that allows a business to perform functions inherent to its administrations, such as placing purchase orders, receiving inventory into inventory balances, performing financial and accounting functions, such as accumulating interest and depreciation, and the like. The ERS may be displayed on the participant's computer display screen in the form of a web page, for example. The web page may be designed by the independent third party and hosted by the independent third party's computer server system, in an exemplary embodiment. Each participant may engage in simulated commerce with, as well as compete with, a plurality of other independent participants, who have also organized a virtual company. Each participant preferably has a separate Enterprise Resource System, which ERS may be designed and hosted by the independent third party, and which ERS may be displayed on the computer of the participant.

Commerce within the virtual economy may be driven by real currency that is paid to the independent third party for holding. Credit on that real currency may then be used in the economy as capital for generation of a virtual company. The conversion of real currency to the economy's currency may be performed using a mathematical conversion predetermined in accordance with a fixed rate. The balance of that conversion may be debited into a virtual account for the virtual company for use in the economy. The virtual account may be used by the participant for activities within the economy environment. For example, the participant may buy virtual fixed assets, pay virtual employees, and buy virtual inventory. The economy as a whole, and the independent virtual companies engaging in commerce within it, are “mutually dependant” to perpetuate the economy's viability. As such, each virtual company may have an independent participant acting as a supplier, and another acting as a customer, for each transaction, as discussed further hereinbelow. However, it is possible for an independent participant to elect to serve multiple roles, such as supplier, manufacturer, and/or customer, based on the participants strength of assets within the economy. As commerce occurs over a period of time, each individual participant's virtual company may make a profit or lose money as represented by the virtual currency used in the economy. However, the total value of real currency in the economy is preferably equavalent to the sum entered into the economy of the total of all participants' capital investments to start each virtual company. The economy is thus a closed system with regard to real currency. Consequently, if a participant decides to cease the operations of the virtual company, the equivalent value of real currency in the economy is equal to the value of the economy's current value less the value of the reimbursement by the independent third party for withdrawal from the economy.

In the instance wherein a participant withdraws from the economy, the cash balance of that participant's virtual company's cash account is that which remains after divesting all virtual assets within the economy and accounting for the virtual currency to real currency conversion at the fixed rate predetermined. Because the economic system is closed, real currency is preferably not created or lost, simply transferred within the economy through commercial activity; as occurs in the real-world. Thus, individual participants may make a profit, or sustain a loss, based upon the business dealings of those participants within the economic simulation. However, the total monetary value of actual currency preferably remains the same. This constant value of actual currency may vary in accordance with a tracking of the value of the simulation currency versus actual currency, in a manner similar to the tracking of foreign currency values versus the U.S. dollar, or may vary dependant upon the results of any investing carried out by the independent third party, as discussed further hereinbelow.

Each individual ERP preferably includes various “sub-pages” relating to an individual aspect of the virtual company's administrations, such as purchasing, inventory, accounting, and the like that are in communicative connection to other participant's virtual companies through the connection with the client server system. For example, a virtual company may need to place a purchase order to another participant's company and buy virtual inventory for use in producing virtual products. The first company, via the Enterprise Resource System, initiates a purchase order from the “Purchasing” sub-page, and electronically sends it to the client system of the virtual company that is the intended recipient. The participant that is the intended recipient accesses an appropriate sub-page, such as a “Customer Order” sub-page, in order to process the order.

The independent third party (ITP) preferably provides the structure of the economy that encompasses each virtual industry, and each virtual organization or company within each virtual industry. For example, a paper industry within the economy may include a logging organization, a milling organization, a paper manufacturing organization, a trucking organization, a distributor of paper products, a book publisher, a newspaper organization, a magazine publisher, and so on. The make-up of organizations within each industry within the economy may be different based on the characteristics or needs of the industry involved. The client system is preferably programmed with each individual working aspect of each virtual organization within that industry, as well as each characteristic of each virtual product that is manufactured, bought or sold by each virtual organization.

In an exemplary embodiment, the basic virtual industry may be composed of eight different types of virtual organizations that engage in commerce within that industry. Independent participants may choose to set up a particular type of organization upon investment of the requisite start up capital. In this example, the virtual company types include: 1) a Tin Miner; 2) a Steel Miner; 3) a Truck Manufacturer; 4) a Truck Engine Manufacturer; 5) a Truck Body Manufacturer, 6) a Freight Trucking Company; 7) and a Drill Bit Manufacturer. Initially, the independent third party may provide, within its server system, a visual map of the economic environment wherein this commerce occurs, for the purpose of displaying selectable virtual locations for any of the virtual companies or organizations. Additionally, the client system may be programmed with virtual distances within that economic environment. For example, a simulated map of the United States may be the basis for the virtual map and the virtual distances. In an embodiment of the present invention, the user may have the ability to movie about in a virtual world by “seeing” warehouses, factories, materials, people, and the like in, for example, a three-dimensional environment.

The independent third party may provide the internal aspects of each virtual company or organization including, but not limited to, the virtual fixed assets needed to run the virtual company, and the associated virtual costs, direct virtual costs, such as virtual labor costs, virtual inventory costs, etc., indirect virtual costs, such as the virtual time it takes to produce a product, and each specific characteristic of the product produced, as well as recognition of the virtual characteristics of products used with the virtual production process. In an exemplary embodiment, the independent third party may instantiate within its server a working virtual tin mining company to fuel the virtual industry with a source of tin. Initially, the independent third party may place the tin mining company in one particular place on the virtual map. The independent third party may establish the needs of the tin mining company for the mining of the virtual tin, and sets a virtual cost for each aspect of establishing a working company to produce the virtual tin product. For example, the independent third party may establish that the tin mining company needs a drill bit to mine virtual tin. This requirement of a drill bit for tin mining operations sets up a dependency of the tin mining organization with that of a drill bit manufacturer. Virtual economic inter-relationships are thus instantiated to make the economy function.

At the inception of the virtual economy, all aspects needed to run each individual virtual company may be programmed into the economic environment. For example, the tin mining company might be allotted a drill bit made of steel having a representative value. A physical manifestation of the virtual tin mining company may be represented on the virtual map. However, because it is operated by the independent third party, the virtual tin mining company may not evidence a physical manifestation on an Enterprise Resource System as would individual participants. The independent third party operated tin mining company preferably has the functionality required to interact with other participants. This functionality is preferably embodied in a program resident in the independent third party's server system. In the embodiment wherein the independent third party is active within the economy, it is preferred that the independent third party act as a “linear” participant, as set forth hereinbelow.

Furthermore, the tin mining company may be allotted a virtual inventory of virtual product with an associated cost. In the present example, the volume of tin ore available may also be expressed in a convenient unit of measure, such as pounds. The physical representation of each unit of virtual product may be expressed as a number in an inventory ledger. The ledger may be represented in an inventory ledger sub-page of the Enterprise Resource System web page of an individual participant, for example. Such a sub-page inventory ledger might then be accessible to any individual participant.

Each individual participant preferably has its own Enterprise Resource System web page access that allows the individual participants to establish, maintain, and control its interactions in the economy. In order to track the interconnection of one participant's virtual company to other virtual companies, each unit of individual product held by an individual participant also may have programmed within it an identifier, such as an exclusive number, which identifies users of that particular product in other virtual manufacturing processes. Furthermore, any virtual equipment used in any production process may have programmed within it the virtual raw product that the virtual equipment is made of, as well as the rate of process that it is performing. Thereby, production efficiency, measured in the amount of virtual is produced within a set time frame relative to the raw materials used, is set. This information characterizes the economic dependency of one virtual company on others. Other virtual organizations are similarly programmed in accordance with the independent third party functionality.

In an additional exemplary embodiment, a first virtual organization may be structured into, for example, a tin mining company. The virtual tin mining company may be allocated one or more essential resources to enable functionality, such as, for example, a drill bit to mine tin. The allocated resources are assigned a cost and specific characteristics. For example, the tin mining drill bit may cost one hundred virtual dollars, and the bit may be characterized as being made of steel, and may be characterized by a specific depreciation. The drill bit may be manufactured by one or more other virtual organizations that provide mining bits made of steel. Thus, an interdependency may be established linking the tin mining operation to the steel mining bit manufacturer. The virtual tin mining organization is also preferably allocated an initial set of costs of operation such as, for example, the costs of labor for extracting tin from a mine, and the cost of packaging the raw tin for transport. Other parameters of operation are also initialized such as, for example, an extraction time for each pound of tin that is mined. An undelivered price of tin thus may be an appropriate combination of labor costs per unit extraction time, arid overhead costs for maintaining operations, and the purchase of needed resources such as, for example, the tin mining drill bit. The final cost to a customer may be the cost of undelivered tin ore and subsequent transportation costs via another virtual organization.

The economic simulation may provide an initial value for inventory of mined raw tin. Alternatively, after a pre-determined amount of time, it may be provided to the virtual tin mining company an inventory of mined tin, expressed in a unit of measure, and valued at the amount equal to the cost expended in mining the tin.

The structure of other virtual organizations are set up similarly, with an initial set of resources to enable functionality and links of interdependency to other organizations for materials input and product output, as would be present in a functional real economy. For example, the steel mining company would preferably be able to sell mined ore to a manufacturer of mining drill bits or a steel mill for the production of sheet metal for truck bodies.

The structure of different organizations may take slightly different forms based upon functional needs. For example, if a participant wishes to select truck engine manufacturer as the virtual company, programming may be different from that of the mining operation. Specifically, the truck engine manufacturing simulation programming may contain the virtual manufacturing process described by various rules tailored to the functional operation within the economy. For example, the engine can be made of two pounds of steel or two pounds of tin, and each will work within the constraints of the programming. However, at the initiation of the simulation, the Bill of Material may contain a requirement for two pounds of tin. Alternatively, the participant may have to elect whether other materials are suitable substitutes such, as steel or copper. The participant may click on the “purchasing” module of the Enterprise Resource System, and may enter a bank Purchase Order which may be available as an HTML document, to enable procurement of an alternate material, such as, for example, steel, if the two pounds of tin are unavailable in the economy. The participant then fills out a purchase order and submits the purchase order to the client system of the virtual steel miner that supplies steel. The purchase order may be filled, based on the availability of steel, at the present price determined by the steel manufacturer simulation. Upon filling the purchase order, the steel manufacturer subtracts two pounds of steel from virtual inventory by actuating functionality on the inventory sub page. The steel manufacturer then must arrange for transportation of the steel to the truck engine manufacturer. This may be accomplished, for example, by contacting a virtual trucking company to deliver the goods. Furthermore, the seller must access a separate sub page of the ERS and send the issuer of the purchase order an invoice stating what was sent and what the cost is. When the goods are received after the trucking company “delivers” them, the truck engine manufacturing company must access a part of the ERS and add the two pounds of steel into the virtual inventory.

For example, for a participant that sets up a truck engine manufacturing company, the virtual manufacturing process may be programmed as: IF raw material=tin (whatever the identifying number is) THEN the time to produce an engine of tin=(x amount of time) and the result=1x (engine of tin with a unique number). If the participant decides to use steel, the programming is such: IF raw material=steel (whatever the identifying number is THEN the time to produce an engine of steel=(different amount of time with a different cost) and the result=1x (engine of steel with a unique number). These variables are also assigned a cost. The cost of raw materials is transferred to the selling virtual company when the buyer accesses a separate sub page of the ERS and pays the virtual invoice. The other costs, such as the virtual labor costs, are deducted from the participants account.

Similarly, the set-up of a truck manufacturer within the economy may include a bill of materials that includes, for example, a truck body and a truck engine. The truck manufacturer participant may be required to place separate purchase orders to secure the materials needed to produce a truck. The participant sends a purchase order to each supplier, the truck body manufacturer, and the truck engine manufacturer, by the method described hereinabove. In the current example, there are multiple cost variables. The engine procured may be made of tin or steel, each with its own associated costs. The same may be said of the truck bodies that may be made from either tin or steels, and which may include associated manufacturing times, labor charges, and raw materials costs.

For example, the truck manufacturing process may be programmed as: IF truck body=x (steel truck body) THEN time to produce=m (time). Or IF truck body=y (tin truck body) then time to produce=m (time) (different time and associated cost) AND IF truck engine=a (steel truck engine) THEN time to produce=c (time)+m. IF truck engine=b (tin truck engine) THEN time to produce=c (time)+m. These variables are also assigned an associated cost.

The truck manufacturer now may sell the product to a trucking company that delivers virtual goods to others in the economy. By way of the method described earlier, the trucking company buys a truck. The trucking company's business is to deliver goods from one person to another within the virtual economy. But, the virtual trucks have a useful lifetime, as well as associated maintenance costs. Thus, the useful life of a truck may depend on whether the engine and/or body is made of tin or steel, and the relative durability of those materials, and may depreciate.

There may be multiple interdependencies between virtual organizations. For example, the drill bit manufacturer may use steel or tin to manufacture drill bits. A steel drill bit may last longer than a tin drill bit, and thus may command a correspondingly higher price. These drill bits are used to mine steel and tin for use in truck bodies. Thus, interdependency may be simulated in the economy.

The hereinabove example of an interdependent virtual industry consisting of separate organizations represents one possible industry within the economy. For example, the included industries may include manufacturing of various types such as paper goods, consumer electronics, office supplies, automobile, business goods, etc., transportation, air rail, truck, etc., fuel, oil, gasoline, coal, etc., banking, savings and loan, as well as other interdependent enterprises. A multitude of such industries may be generated and interactively deployed. An optimum operating condition for the economy occurs when participants fill the diverse industry structure within the economy. The economy then becomes self-perpetuating, and the independent third party can withdrawal from operating any virtual organizations or businesses. Before each virtual organization is operated by one or more participants, the independent third party must “fill in the spaces” of the economy with virtual organizations at cost. The independent third party preferably acts as a substitute for a participant in an industry that is required for the economy to function. For example, if there is at least one independent participant operating each type of company, except the truck manufacturer, the independent third party of non-interest may operate as a truck manufacturer to ensure the perpetuation of the economy, but may make no profit or loss in the operation. Therefore, the independent third party operator of the truck manufacturer would incur costs for raw materials and labor, which would determine the price of a finished truck. However, the cost of the truck produced would not include additional cost to the buyer attributed to profit.

The specific examples of organizations and industry segments provided hereinabove are set forth as examples only. The entire economy may be composed of multiple thousands of different organizations or companies. In one embodiment, each product of interest of the various organizations may have a Bill of Materials of 15-20 individual items produced within the economy. Thus the number of interdependencies multiplies such that the failure of, for example, a single product consumer, does not necessarily cause a stoppage of commerce within the entire industry. Additionally, with a large number of participants, the economy would be vital despite the failure, or success, of one or two organizations.

According to an additional feature of the present invention, regulatory costs are utilized in the economy by adding the value of those collected costs back into the economy. The value of the costs assessed individual participants of the economy that are not costs in which the virtual currency is transferred from one individual participant to another, such as regulatory costs, and the cost of carrying virtual inventory, and the cost virtual labor, is “put back” into the virtual economy. For example, the total of this value of these costs may be put back into the economy and distributed as, for example, but not limited to, interest to participants who have cash balances in a virtual bank. For example, if a regulatory requirement were imposed that collected simulated currency for the retention of inventory, the funds collected could be used to pay interest to those parties who have interest bearing accounts in a virtual bank. Thus, no virtual currency is generated outside of the closed system economy. For example, assume within the economy, there are 3 virtual companies each with an average inventory value throughout a predetermined period of time of $100.00 as represented by the value of the virtual currency. Furthermore, there has been a set rate of the cost of carrying virtual inventory predetermined by the independent third party and set at 3% of the average inventory value of the 3 virtual companies at the end of a predetermined period of time. At this point the value of the of the total costs of carrying inventory within the whole economy is $9.00 as calculated by the independent third party's server/computer system and as represented by the value of the virtual currency. The $9.00 of virtual currency is put back into the economy because the independent third party who provides the forum for the economy has no fiscal interest in the economy's administrations. The same 3 companies have respective values of $20.00, $15.00, and $10.00 as cash balances as represented by the value of currency in the virtual bank. The interest rate for this specific predetermined period of time would be 20%, with the participant with a cash balance of $20.00 earning $4.00 in interest, the participant with $15.00 earning $3.00 and the participant with $10.00 earning $2.00 in interest for a total of the original $9.00.

According to an additional feature of the invention, all transactions occurring within the virtual economy, and data thereby produced including, but not limited to, sales data in units, sales data in dollars, purchasing data in units, purchasing data in dollars, production data in units, production data in dollars, labor costs, etc., are stored within the central server system, and are accessible for download and analysis by each individual participant via the Enterprise Resource System web page and sub-pages.

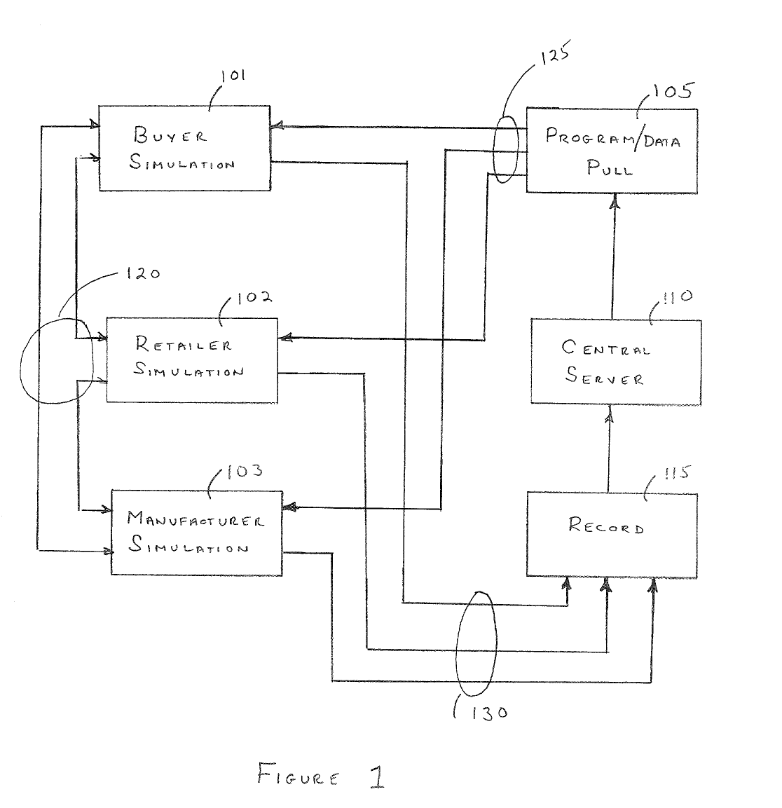

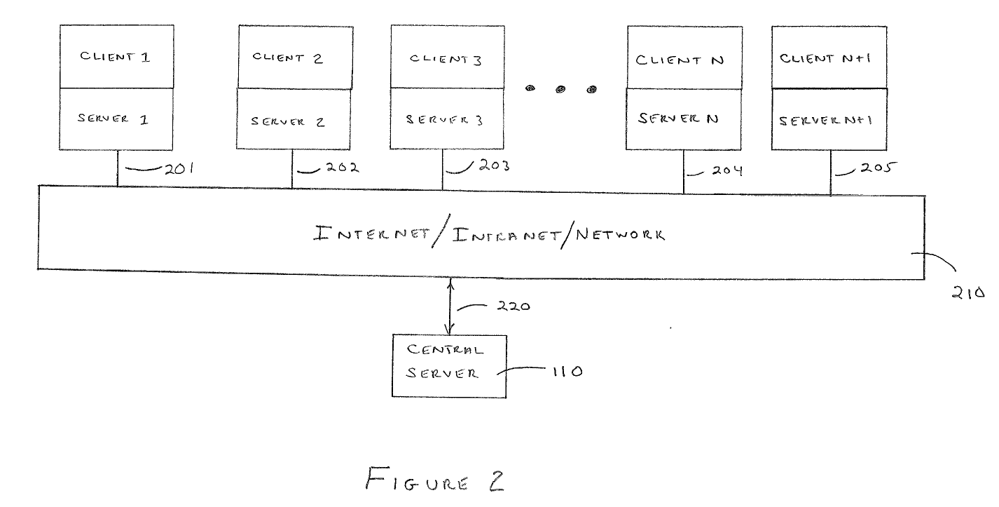

FIG. 1 is a block diagram of exemplary interrelations for participant activities in the present invention. A buyer of goods 101, a retailer of goods 102, and a manufacturer of goods 103 are represented. Initially, software of the present invention is “pulled” from a central server (see FIG. 2) by a program/data pull function 105 acting in response to a request from the participant 101-103. The pulled software load may be transmitted over communications link 120, and may include such information as is necessary to employ the enterprise resource system (ERS) for an individual enterprise by the specific participant. Additionally, the software/data pulled from the central server 110 may include the software and data necessary to supplement the proper operation of the participant's enterprise via the independent third party. Thus, independent third party operations, such as communications sent to the third party, and the protocol thereof, may run within the participant's simulation 101-103, as is necessary.

Functionally, each participant may communicate with each other participant via communication link 120, thereby allowing two way channels, i.e. “push” and “pull” channels, for interaction between and among the participants. No central server interaction need occur to allow for execution of the present invention. The central server is preferably a “passive element”, meaning that the central server may serve as a recording instrument via a record request function 130. The link between the central server and the participants is a one-way link. For example, the central server may not serve only to record across a one-way link, but may additionally serve to respond to requests for data from at least one of the participants. However, unlike the prior art, communication between participants does not occur “through” the central server. A request for a communication from participant 1 to participant 2 is not sent to the central server from participant 1, and then sent on as a message from the central server to participant 2. Rather, participants 1 and 2 communicate directly in the present invention, and the central server passively records the interaction. In the instance wherein participant 1 requests information from the central server, participant 1 is allowed to “pull” the requested information only to participant 1 from the central server. Participant 2 is not involved in any central server transaction involving participant 1. It should be noted that this interrelation methodology may provide enhanced security, and this security may be further enhanced by providing limitations on the information about other participants that is made available for a request by participant 1, as will be apparent to those skilled in the art. The central server is preferably not involved in any communication between participants 1 and 2, and is only involved discreetly with participant 1 to record activities of, and/or respond to information requests of, participant 1, and discreetly with participant 2 to record activities of, and/or respond to information requests of, participant 2. Status of the economy may be recorded either as the simulation is ongoing, or at the end of a predetermined period, such as daily. For example, the recorder function 130 may be invoked when any data transaction occurs between participants wherein simulated goods, money or documents are transferred, or may be invoked at the end of each week of such activity. Because the present invention provides two-way communication between and among participants, and inter-participant communication preferably does not involve the central server, the present invention may be said to provide a “linear” relation between participants, rather than a “hub and spoke” relation among participants through the central server.

In accordance with the illustration of FIG. 1, commerce preferably occurs within the present invention in the same manner it occurs in the actual world. For example, a steel manufacturer communicates directly with a truck engine manufacturer, but does not typically communicate directly with the truck sales personnel. The interactions between the users of the present invention occur directly with other users of the present invention, and the central site records the activity, such as in real time, in order to track, for example, use of the game by a particular user. This is preferably true for all participant businesses in the game.

FIG. 2 is a schematic diagram of the networked hardware and software in the present invention. Typical client/server type interfaces 201-205 for the participants may be used to interconnect to an internet, intranet, or other private or public network 210, in order to access and use the present invention. The central server 110 is connected to the network 210, but is preferably not involved in participant to participant communications. Participant to participant communications occur via the interconnection network 210. The central server functions to supply initial program information to the individual participant's client/server interface, to record transactions within the present invention, and to respond to discreet participant information requests, via a standard network connection 220.

The present invention may be operable in conjunction with a workstation 201, 203, 205 having resident thereon an operating system, such as, but not limited to, Microsoft Windows XP, NT or Windows/95 Operating System (OS), the IBM OS/2 operating system, the MAC OS, or UNIX operating system.

An embodiment of the invention may be implemented, for example, using xml, JAVA, C, or C++ languages, and preferably utilizes object oriented programming methodology (“OOP”). OOP is a process of developing computer software using objects, including the steps of analyzing the problem, designing the system, and constructing the program. An object is a software package that contains both data and a collection of related structures and procedures. Since it contains both data and a collection of structures and procedures, it can be visualized as a self-sufficient component that does not require other additional structures, procedures or data to perform its specific task. The concept of packaging data, structures, and procedures together in one component or module is known in the art as encapsulation.

In general, OOP components are reusable software modules which present an interface that conforms to an object model and which are accessed at run-time through a component integration architecture, i.e. a set of architecture mechanisms which allow software modules in different process spaces to utilize each others capabilities or functions, such as by assuming a common component object model on which to build the architecture.

An object within the model is a single instance of the class of objects, and class of objects can be viewed as a basic software construct. For example, the object representing an assembled truck is said to have a composition-relationship with the object representing a truck engine. In reality, an assembled truck includes a truck engine, chassis, wheels, and other components. The fact that a truck engine is an element of an assembled truck can be logically and semantically represented in OOP by two objects.

If there are two objects, one representing a assembled truck and the other representing an assembled truck wherein the truck engine is made of aluminum, then the relationship between the two objects is not that of composition. An aluminum assembled truck does not make up a truck engine. In this case, the object representing the aluminum engine-assembled truck is called a derived object, and it inherits all of the aspects of the object representing the assembled truck and adds further limitation or detail. The object representing the aluminum engine-assembled truck “depends from” the object representing the truck engine. The relationship between these objects is called inheritance.

When the object or class representing the aluminum engine-assembled truck inherits all of the aspects of the objects representing the truck engine, it inherits the wear and tear, or expected lifetime, characteristics of a standard truck engine defined in the assembled truck class. However, the aluminum assembled truck object overrides these specific expected lifetime characteristics, because these limitations are typical only for a steel truck engine. Different kinds of truck engines have different characteristics, but may have the same underlying functions associated therewith, e.g., how much metal is needed for the engine, how long it takes to manufacture, additional materials required such as an ignition system, lubricating oil, etc. In order to access each of these functions in any assembled truck object, a programmer would call the same functions with the same names, but each type of assembled truck would have different/overriding implementations of functions behind the same name. This is called polymorphism.

Objects can represent physical objects, such as manufacturing plants, and/or inventory or manufactured items, such as trucks, engines, drill bits, consumer goods, geographic regions, money, purchase orders, etc. Objects can also represent elements of the computer-user environment such as windows, menus or graphics objects, and user-defined data types such as data in a purchase order, a time for manufacture, or locations.

This process of using OOP closely resembles complex machinery being built out of assemblies and sub-assemblies. Thus, the structure of OOP is well-suited for an economic simulation wherein industries constructed of interrelating assemblies are used. Additionally, the use of OOP technology, therefore, makes software engineering more like hardware engineering in that software is built from existing components, which are available to the developer as objects. This generates an improved quality of the software as well as an increased speed of its development.

Graphical user interfaces in OOP allow the user, rather than program logic, to drive the program and decide when certain actions should be performed. Preferably, the personal computer software being used by the individual player of the economic simulation accomplishes control within the system by means of an event loop which monitors the mouse, keyboard, and other sources of external events and calls the appropriate parts of the programmer's code according to actions that the user performs. A program is divided into separate pieces that are called at unpredictable times and in an unpredictable order. Nevertheless, individual pieces of the program written by the developer still call libraries provided by the operating system to accomplish certain tasks, and the programmer must still determine the flow of control within each piece after it is called by the event loop.

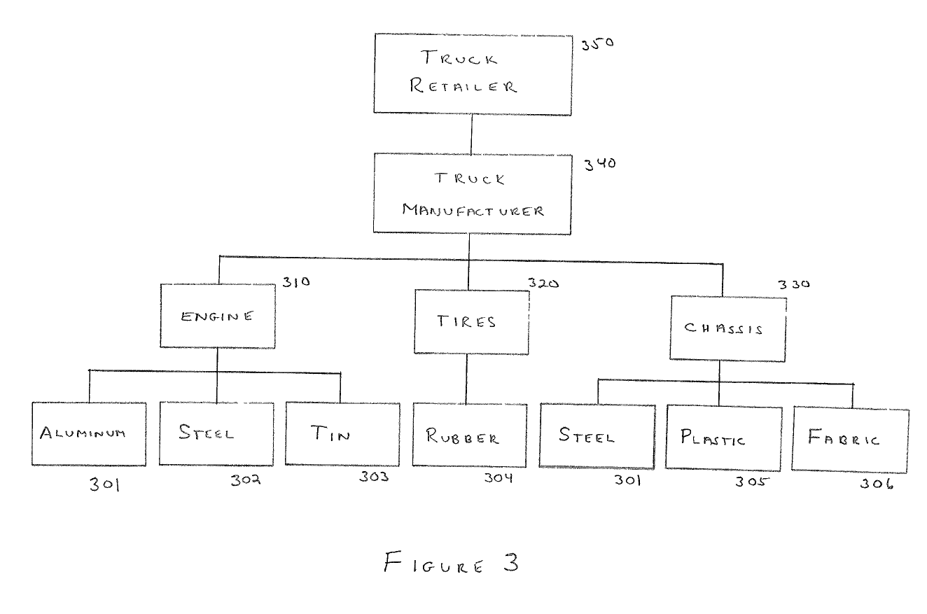

FIG. 3 is a block diagram illustrating an exemplary embodiment of a simulation of the present invention. Raw materials, such as aluminum 301, steel 302, tin 303, rubber 304, plastic, 305 and fabric 306 are needed in an industry to assemble truck engines 320, tires 330, and chassis 340. The raw materials are procured from varied industries, such as the mining industry for the metals, and are critical for higher level assemblies. Subassemblies, such as engines, tires, and truck chassis are assembled to form a completed truck 340. Finally, the truck is sold via a retailer 350 within the economy. FIG. 3 is simplified and, as one of ordinary skill in the art will recognize, may be more complex for a given industry based on the chosen complexity of the simulation. In addition, resources and factors such as labor, time, and expense are attributes in each element and are preferably coded parameters of the economic simulation.

In an embodiment of the present invention, the pay-in for each participant may be entered to a pay-in pool, and the pay-in pool may be invested by the objective third party, such as in a secure or non-secure investment, and return on that investment may either be dispersed to the participants upon exit of the participant from the game, or may be retained by the objective third party as a fee for services provided. It will be apparent to those skilled in the art, that, where non-secure investments are undertaken with the pay in values by the objective third party, the objective third party may be subjected to a series of predetermined standards, such as banking industry standards. Dependent upon the relative predetermined standards, participants may either be informed, or not be informed, of the investing performed by the objective third party, and the results thereof, with the total pay-in values.

According to an additional feature of the invention, there may be within the economy a client to client chat and email system via the system server, which may be independent from any real world chat or email system. As with other documents, such as purchase orders, the server may keep records of the email and chat activities for future reference within the economy, subject to privacy concerns that will be apparent to those skilled in the art.

Additional embodiments of the invention will be apparent to those skilled in the art. For example, a total time limit may be placed upon operations within the economy, such that the total simulation time may be limited to, for example, a three month period wherein participants may compete with one another for organizational success within the limits of the simulation. Such alterations will be readily apparent to one of skill in the art, and are therefore not discussed herein. Consequently, those of ordinary skill in the art will recognize that many modifications and variations of the present invention may be implemented. The foregoing description and the following claims are intended to cover all such modifications and variations.

What is claimed:

1. An system for providing a channel between at least two organizations, wherein the organizations are linearly communicatively connected, comprising:
an account for each of the at least two organizations;
a set of defined attributes for each of the at least two organizations, wherein each of said at least two sets is correspondent to one of said accounts, wherein said set defines at least one input to the organization correspondent to the one of said accounts and at least one output of the organization correspondent to the one of said accounts;
a communicative connection that provides for at least one of said organizations to control said account of that at least one organization, and that provides for a linear interacting of the at least one of said organizations with other of said at least two organizations, wherein the linear interacting comprises trading of said set correspondent to the at least one of said organizations within the system by the at least one of said organizations with other of said at least two organizations; and
a disinterested third-party connection that provides for the creation of each of said accounts, that records activities occurring over said communicative connection, and that serves as a temporary organization if the system is without at least one of said at least two organizations necessary for at least one of the linear communications.

2. The system of claim 1, wherein one of said set of defined attributes is a simulated currency.

3. The system of claim 1, wherein one of said attributes is a simulated location whereat the organization resides.

4. The system of claim 1, wherein the system is resident on a computer.

5. The system of claim 1, wherein the communicative connection provides the organizations with a closed, recorded chat system.

6. The system of claim 1, wherein the communicative connection provides one of the at least two said organizations with an email system located at said disinterested third-party connection.

7. The system of claim 1, wherein the communicative connection provides at least one of the at least two said organizations with a set of at least one feedback page of consolidated information documenting transactions effecting said account of that at least one organization.

8. The system of claim 1, wherein said organizations initiate the simulated economy concurrently.

9. The system of claim 1, wherein an entry and exit of said organizations is discretionary.

10. The system of claim 1, wherein each of said accounts is created by said independent third party in accordance with a pay-in by each of said organizations.

11. The system of claim 1, further comprising an investment account, wherein all of the pay-ins are placed in said investment account, and wherein said investment account is invested by said independent third party, and wherein proceeds of said investment account are distributed to each of said organizations in accordance with the pay-in of each respective one of said organizations.

12. The system of claim 1, further comprising an investment account, wherein all of the pay-ins are placed in said investment account, and wherein said investment account is invested by said independent third party, and wherein proceeds of said investment account are retained by said independent third party.

13. The system of claim 1, wherein the system quantifies characteristics of each product or service that is transacted within the system within said accounts.

14. A computer implemented method of providing a linear channel of communication between at least two organizations, the method comprising:
creating an account for each of at least two organizations;
identifying and assigning a set of defined attributes for each of the at least two organizations;
establishing a communicative connection allowing at least one of the organizations to manage and control the account of that at least one organization, and to linearly interact with others of the at least two organizations;
serving as a temporary organization in an absence of at least one of said at least two organizations necessary for a trading of the sets;
recording the trading of the sets of defined attributes over the communicative connection; and
allowing for the trading of the sets of defined attributes between the organizations.

15. The method of claim 14, wherein one of said set of defined attributes is a simulated currency, wherein a value of said simulated currency is determined by valuing an input currency using the following steps:
receiving the input currency at a disinterested third-party;
converting the input currency to the simulated currency using a pre-defined mathematical relation;
crediting the simulated currency resulting from the conversion to a respective one of the accounts.

16. The method of claim 14, wherein creating the accounts defines the linear interaction of the organizations.
